(19) United States
(12) Patent Application Publication
(10) Pub. No.: US 2012/0054724 A1
(43) Pub. Date: Mar. 1, 2012

(54) INCREMENTAL STATIC ANALYSIS

(75) Inventors: Daniel Kalman, Tel Aviv (IL); Marco Pistoia, Amawalk, NY (US); Guy Podjarny, Ottawa (CA); Omer Tripp, Har-Adar (IL); Omri Weisman, Tel Aviv (IL)

(73) Assignee: INTERNATIONAL BUSINESS MACHINES CORPORATION, Armonk, NY (US)

(21) Appl. No.: 12/873,219

(22) Filed: Aug. 31, 2010

(51) Int. Cl. G06F 9/44

(52) U.S. Cl. 717/131

(57) ABSTRACT

A system, method and computer program product for incremental static analysis, including a change impact analyzer for identifying a changed portion of a computer software (e.g., an application), where the changed portion was changed subsequent to performing a static analysis on the application, a static analysis result invalidator for invalidating any static analysis result that is dependent on the changed portion, and an incremental static analyzer for performing a first incremental static analysis on at least the changed portion, presenting the results of the first incremental static analysis, receiving a request to provide additional information regarding a selected result of the first incremental static analysis, performing, responsive to receiving the request, a second incremental static analysis on any portion of the application to gather the additional information, and presenting results of the second incremental static analysis, thereby providing the additional information regarding the selected result of the first incremental static analysis.

### BACKGROUND

Static analysis of a computer software application typically involves tracing the flow of data within the application. For example, static analysis may be used to trace the flow of data from a “source” of data within the application, such as from an instruction in which a variable receives data that are input into the application via a user interface, to a “sink” within the application, such as to an instruction that writes the source data to a database, via any intermediate instructions. It is well known that once an application has been statically analyzed, any changes subsequently made to the application may affect the validity of the analysis results. Thus, for example, if an instruction is deleted, the reliability of the analysis results may be called into question if any data flows identified during the static analysis depended on the deleted instruction.

### SUMMARY

In one aspect of the present invention a system is provided for incremental static analysis, the system including a change impact analyzer for identifying a changed portion of computer software, where the changed portion was changed subsequent to static analysis having been performed on the computer software, a static analysis result invalidator for invalidating any result of the static analysis, where the result is dependent on the changed portion, and an incremental static analyzer for performing a first incremental static analysis on at least the changed portion, presenting, via a computer-controlled output medium, results of the first incremental static analysis, receiving a request to provide additional information regarding a selected result of the first incremental static analysis, responsive to receiving the request, performing a second incremental static analysis on any portion of the computer software to gather the additional information, and presenting, via the computer-controlled output medium, results of the second incremental static analysis, thereby providing the additional information regarding the selected result of the first incremental static analysis.

In another aspect of the present invention a method is provided for incremental static analysis, the method including identifying a changed portion of computer software, where the changed portion was changed subsequent to static analysis having been performed on the computer software, invalidating any result of the static analysis, where the result is dependent on the changed portion, performing a first incremental static analysis on at least the changed portion, presenting, via a computer-controlled output medium, results of the first incremental static analysis, receiving a request to provide additional information regarding a selected result of the first incremental static analysis, responsive to receiving the request, performing a second incremental static analysis on any portion of the computer software to gather the additional information, and presenting, via the computer-controlled output medium, results of the second incremental static analysis, thereby providing the additional information regarding the selected result of the first incremental static analysis.

A computer-program product embodying the invention is also provided.

### BRIEF DESCRIPTION OF THE DRAWINGS

The invention will be understood and appreciated more fully from the following detailed description taken in conjunction with the appended drawings in which:

FIG. 1 is a simplified conceptual illustration of a system for incremental static analysis, constructed and operative in accordance with an embodiment of the invention;

FIG. 2 is a simplified flowchart illustration of an exemplary method of operation of the system of FIG. 1, operative in accordance with an embodiment of the invention; and

FIG. 3 is a simplified block diagram illustration of an exemplary hardware implementation of a computing system, constructed and operative in accordance with an embodiment of the invention.

### DETAILED DESCRIPTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

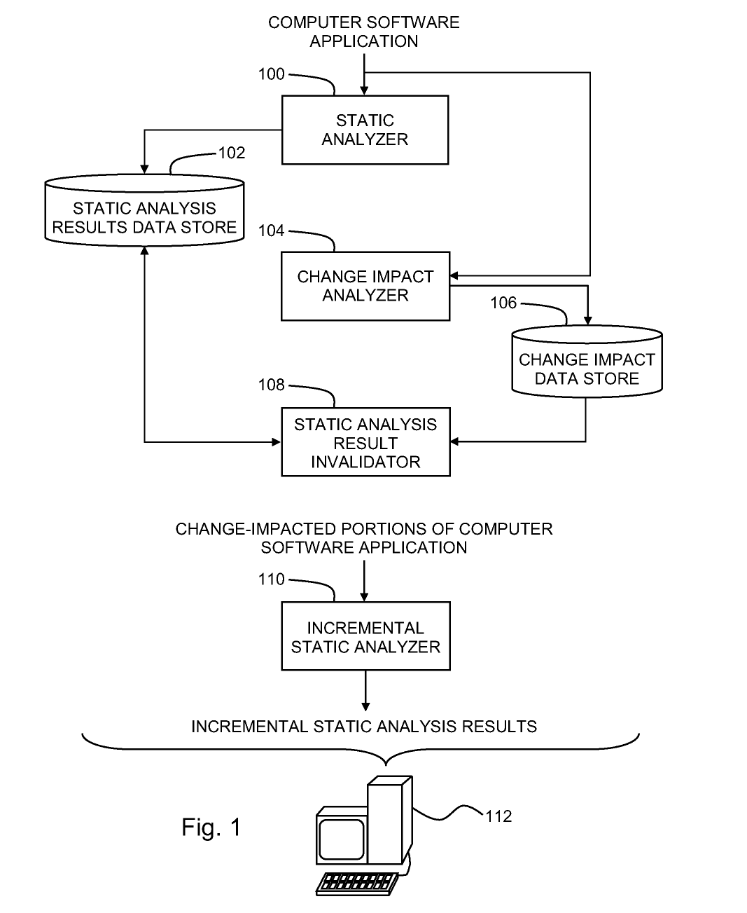

Reference is now made to FIG. 1 which is a simplified conceptual illustration of a system for incremental static analysis, constructed and operative in accordance with an embodiment of the invention. In the system of FIG. 1, a static analyzer 100 is configured to statically analyze computer software (shown in the computer as an application; but may more generally be any software), such as by analyzing the instructions of a computer software application where the instructions are in the form of source code or bytecode, to identify potential vulnerabilities within the application. Static analyzer 100 is configured to perform static analysis, e.g., in accordance with conventional techniques or as otherwise described herein. Static analyzer 100 is configured to maintain a record(s), such as in a static analysis result data store 102, for each individual static analysis result, where each record indicates those portions of the application on which each individual static analysis result is dependent. For example, if static analyzer 100 determines that a variable b may be tainted based on the statement b=a, where a is considered to be tainted based on the statement a=getsource( ) static analyzer 100 records the fact that its analysis result regarding b is dependent on its analysis result regarding a, such as by storing the file name and line number of each instruction in a record associated with b in static analysis result data store 102, or by storing the file name and method name where the instructions are found.

A change impact analyzer 104 is configured to perform a change impact analysis to determine if any portion of a computer software application analyzed by static analyzer 100 has been changed subsequent to static analyzer 100 having performed a static analysis of the computer software application. Thus, continuing with the previous example, if the instruction a=getsource( )was changed to a=null subsequent to static analyzer 100 having performed a static analysis of the computer software application, change impact analyzer 102 is configured to detect this change. Change impact analyzer 104 is also preferably configured to determine the direct or transitive impact of a detected change on one or more other portions of the computer software application, and preferably records the results, such as by recording the file name and line number of each changed instruction and each instruction otherwise impacted by a changed instruction in a record in a change impact data store 106, or by storing the file name and method name where such instructions are found.

A static analysis result invalidator 108 is configured to invalidate any individual result of a static analysis that was performed on a computer software application, where the individual static analysis result is dependent on a portion of the computer software application in which a change was made, such as to an instruction, or which is otherwise impacted by a changed portion. Preferably, static analysis result invalidator 108 identifies such individual static analysis results by comparing static analysis result data store 102 with change impact data store 106. Thus, continuing with the previous example, since the instruction a=getsource( )was changed to a=null (as recorded in change impact data store 106), and since the static analysis result regarding b is dependent on the changed instruction (as recorded in static analysis result data store 102), static analysis result invalidator 108 invalidates the static analysis result regarding b, as the assertion that variable b in the instruction b=a may be tainted is no longer supported.

An incremental static analyzer 110 is configured to perform incremental static analysis as follows on any portion of a computer software application, such as a method or a procedure, in which a change was made or which is otherwise impacted by a changed portion. Incremental static analyzer 110 preferably identifies any variables passed into such a portion via a call to the portion, any variables populated by sources that are directly accessed by instructions within the portion, and any variables returned from calls made from the portion, where the identified variables are known to be tainted. Incremental static analyzer 110 then performs static analysis given the identified tainted variables, and preferably presents the incremental static analysis results via a computer-controlled output medium, such as a computer display or printout.

In one embodiment, incremental static analyzer 110 does not initially retrace source-to-sink data flows for any variables that incremental static analyzer 110 determines to be tainted (where the “sink” is an element of the software application that receives input from a source in the application). Rather, incremental static analyzer 110 may present the sinks that were reached with data from tainted variables. A particular sink may then be selected by a user, whereupon incremental static analyzer 110 identifies one or more sources that flow to the selected sink, which information is then presented to the user. A particular source-sink pair may then be selected by the user, whereupon incremental static analyzer 110 identifies one or more paths from the selected source to the selected sink, which information is then presented to the user. It will be appreciated that selectively recomputing path information in this manner in response to specific user requests for information is far less computationally expensive than recomputing all path information as a result of changes made to an application and doing so in advance of specific user requests for information.

Any of the elements shown in FIG. 1 are preferably executed by or otherwise made accessible to a computer 112, such as by implementing any of the elements in computer hardware and/or in computer software embodied in a physically-tangible, computer-readable medium in accordance with conventional techniques.

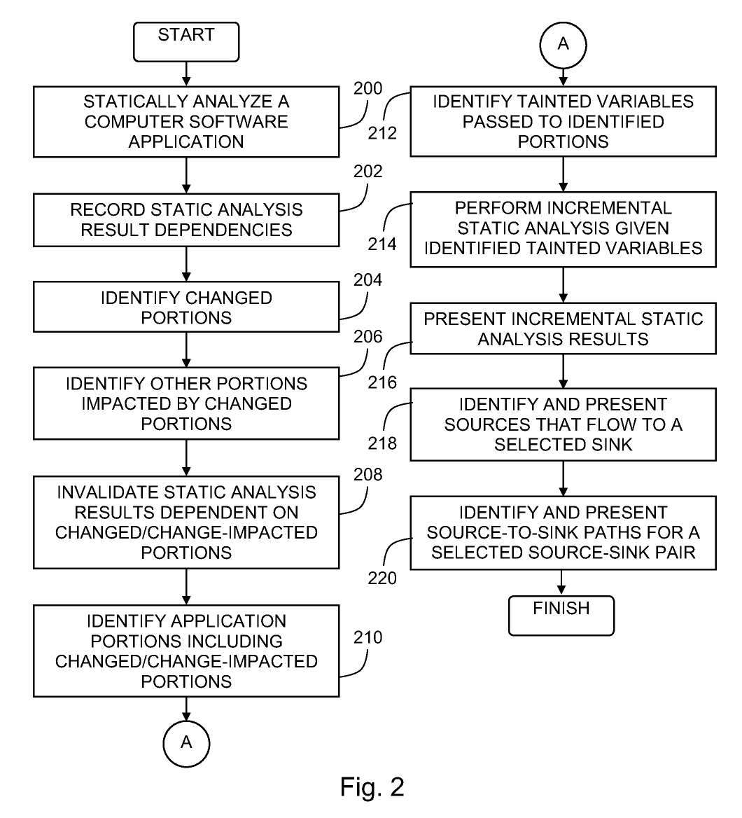

Reference is now made to FIG. 2 which is a simplified flowchart illustration of an exemplary method of operation of the system of FIG. 1, operative in accordance with an embodiment of the invention. In the method of FIG. 2, static analysis is performed of a computer software application (step 200). Those portions of the application on which each individual static analysis result is dependent are recorded (step 202). A change impact analysis is performed to determine if any portions of the computer software application have been changed subsequent to being statically analyzed (step 204). The direct or transitive impact of a detected change on one or more other portions of the computer software application is determined (step 206). Individual static analysis results are invalidated where the individual static analysis result is dependent on a portion of the computer software application in which a change was made or which is otherwise impacted by a changed portion (step 208). Portions of the computer software application are identified in which a change was made or which is otherwise impacted by a changed portion (step 210). Tainted variables passed to any such portion are identified, as are any variables populated by sources that are directly accessed by instructions within the portion (step 212). Incremental static analysis is performed given the identified tainted variables (step 214), and the results of the incremental static analysis are presented via a computer-controlled output medium (step 216). Upon the selection of a particular sink, one or more sources that flow to the selected sink are identified and presented (step 218). Upon the selection of a particular source-sink pair, one or more paths from the selected source to the selected sink are identified and presented (step 220).

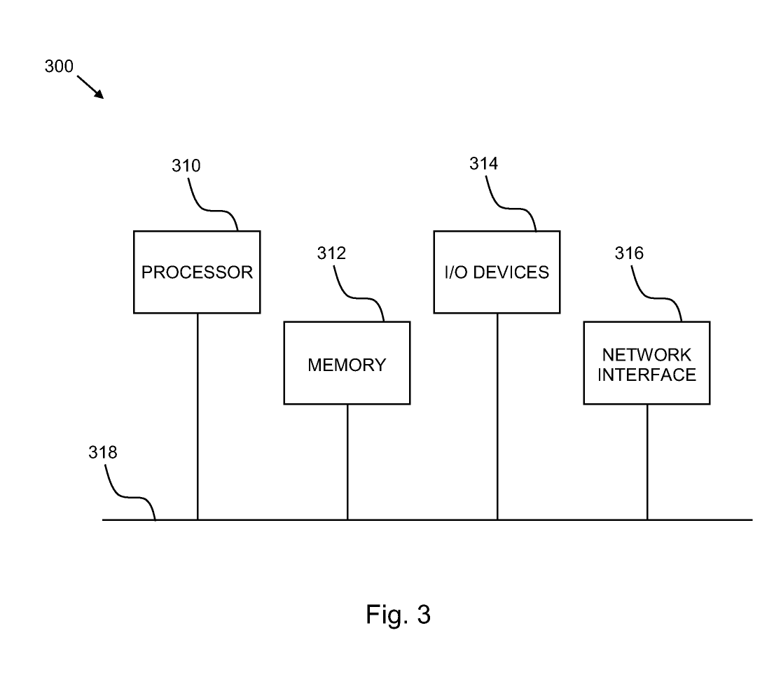

Referring now to FIG. 3, block diagram 300 illustrates an exemplary hardware implementation of a computing system in accordance with which one or more components/methodologies of the invention (e.g., components/methodologies described in the context of FIGS. 1-2) may be implemented, according to an embodiment of the invention.

As shown, the techniques for controlling access to at least one resource may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system, comprising:
a change impact analyzer configured to identify one or more portions of computer software, including at least a changed portion that was changed subsequent to static analysis having been performed on the computer software ;
a static analysis result invalidator configured to invalidate each result of the static analysis that is dependent on the changed portion; and
an incremental static analyzer configured to:
perform a first incremental static analysis on at least the changed portion,
present, via a computer-controlled output medium, results of the first incremental static analysis,
receive a request to provide additional information regarding a selected result of the first incremental static analysis,
responsive to receiving the request, perform a second incremental static analysis on a portion of the computer software to gather the additional information, and
present, via the computer-controlled output medium, results of the second incremental static analysis, thereby providing the additional information regarding the selected result of the first incremental static analysis.

2. The system according to claim 1, further comprising a static analyzer configured to perform the static analysis on the computer software and maintain a plurality of records corresponding to a plurality of static analysis results, wherein each of the records indicates a portion of the computer software on which the corresponding static analysis result is dependent.

3. The system according to claim 1 wherein the change impact analyzer is configured to identify another portion of the computer software other than the changed portion, wherein the changed portion has either of a direct impact and a transitive impact on the another portion.

4. The system according to claim 3 wherein the static analysis result invalidator is configured to invalidate any result of the static analysis, wherein the result is dependent on the another portion.

5. The system according to claim 1 wherein the incremental static analyzer is configured to:
identify any variables passed into the portion on which the incremental static analysis is performed,
identify any variables populated by sources that are directly accessed by instructions within the portion on which the incremental static analysis is performed, and
identify any variables returned from calls made from the portion on which the incremental static analysis is performed,
wherein the identified variables are known to be tainted.

6. The system according to claim 5 wherein the incremental static analyzer is configured to perform static analysis relating to the identified tainted variables.

7. The system according to claim 6 wherein the incremental static analyzer is configured to
identify a sink that was reached with data from any of the tainted variables,
receive a first request to provide additional information regarding the sink,
responsive to receiving the request, identify a source that flows to the sink.

8. The system according to claim 7 wherein the incremental static analyzer is configured to
receive a second request to provide additional information regarding the source-sink pair, and
responsive to receiving the second request, identify a path from the source to the sink.

9. A method, comprising:
identifying one or more portions of computer software, including at least a changed portion that was changed subsequent to static analysis having been performed on the computer software;
invalidating each result of the static analysis that is dependent on the changed portion;
performing a first incremental static analysis on at least the changed portion;
presenting, via a computer-controlled output medium, results of the first incremental static analysis;
receiving a request to provide additional information regarding a selected result of the first incremental static analysis;
responsive to receiving the request, performing a second incremental static analysis on a portion of the computer software to gather the additional information; and
presenting, via the computer-controlled output medium, results of the second incremental static analysis, thereby providing the additional information regarding the selected result of the first incremental static analysis.

10. The method according to claim 9 further comprising:
performing the static analysis on the computer software; and
maintaining a plurality of records corresponding to a plurality of static analysis results, wherein each of the records indicates a portion of the computer software on which the corresponding static analysis result is dependent.

11. The method according to claim 9 wherein identifying one or more portions comprises identifying another portion of the computer software other than the changed portion, wherein the changed portion has either of a direct impact and a transitive impact on the another portion.

12. The method according to claim 11 wherein invalidating comprises invalidating any result of the static analysis that is dependent on the another portion.

13. The method according to claim 9 wherein performing the first incremental static analysis comprises:
identifying any variables passed into the portion on which the incremental static analysis is performed;
identifying any variables populated by sources that are directly accessed by instructions within the portion on which the incremental static analysis is performed; and
identifying any variables returned from calls made from the portion on which the incremental static analysis is performed,
wherein the identified variables are known to be tainted.

14. The method according to claim 13 wherein performing the first incremental static analysis comprises performing static analysis relating to the identified tainted variables.

15. The method according to claim 14 wherein
performing the first incremental static analysis comprises identifying a sink that was reached with data from any of the tainted variables,
receiving the request to provide additional information comprises receiving a first request to provide additional information regarding the sink, and
performing the second incremental static analysis comprises identifying a source that flows to the sink.

16. The method according to claim 15, further comprising:
receiving a second request to provide additional information regarding the source-sink pair; and
responsive to receiving the second request, identifying a path from the source to the sink.

17. A computer program product for incremental static analysis, the computer program product comprising:
a computer-readable storage medium; and
computer-readable program code embodied in the computer-readable storage medium, wherein the computer-readable program code is configured to:
identify one or more portions of computer software, including at least a changed portion that was changed subsequent to static analysis having been performed on the computer software,
invalidate each result of the static analysis that is dependent on the changed portion,
perform a first incremental static analysis on at least the changed portion,
present, via a computer-controlled output medium, results of the first incremental static analysis,
receive a request to provide additional information regarding a selected result of the first incremental static analysis,
responsive to receiving the request, perform a second incremental static analysis on a portion of the computer software to gather the additional information, and
present, via the computer-controlled output medium, results of the second incremental static analysis, thereby providing the additional information regarding the selected result of the first incremental static analysis.

18. The computer program product according to claim 17 wherein the computer-readable program code is configured to:
perform the static analysis on the computer software, and
maintain a plurality of records corresponding to a plurality of static analysis results, wherein each of the records indicates a portion of the computer software on which the corresponding static analysis result is dependent.

19. The computer program product according to claim 17 wherein the computer-readable program code is configured to identify another portion of the computer software other than the changed portion, wherein the changed portion has either of a direct impact and a transitive impact on the another portion.

20. The computer program product according to claim 19 wherein the computer-readable program code is configured to invalidate any result of the static analysis, wherein the result is dependent on the another portion.

21. The computer program product according to claim 17 wherein the computer-readable program code is configured to perform the first incremental static analysis by:
identifying any variables passed into the portion on which the incremental static analysis is performed,
identifying any variables populated by sources that are directly accessed by instructions within the portion on which the incremental static analysis is performed, and
identifying any variables returned from calls made from the portion on which the incremental static analysis is performed,
wherein the identified variables are known to be tainted.

22. The computer program product according to claim 21 wherein the computer-readable program code is configured to perform the first incremental static analysis by performing static analysis relating to the identified tainted variables.

23. The computer program product according to claim 22 wherein the computer-readable program code is configured to:
perform the first incremental static analysis by identifying a sink that was reached with data from any of the tainted variables,
receive the request to provide additional information by receiving a first request to provide additional information regarding the sink, and
perform the second incremental static analysis by identifying a source that flows to the sink.

24. The computer program product according to claim 23 wherein the computer-readable program code is configured to:
receive a second request to provide additional information regarding the source-sink pair, and
responsive to receiving the second request, identify a path from the source to the sink.
